(19) United States
(12) Patent Application Publication
(10) Pub. No.: US 2007/0146142 A1
(43) Pub. Date: Jun. 28, 2007

(54) SECURITY TAG FOR CIGARETTE PACK

(75) Inventor: Andre Cote, Williamstown, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 11/540,000

(22) Filed: Oct. 10, 2006

Related U.S. Application Data
(60) Provisional application No. 60/752,987, filed on Dec. 22, 2005.

(51) Int. Cl. G08B 13/14

(52) U.S. Cl. 340/572.8; 340/572.5

(57) ABSTRACT

A cigarette pack having at least one security tag formed from the metal layer of the cigarette pack liner. One version of the security tag utilizes a preformed coil that is electrically coupled to a portion of the metal layer to form a capacitor and thereby complete a coil/capacitor security tag. Another version of the security tag is forms the entire antenna from the metal layer and a radio frequency identification (RFID) integrated circuit is then coupled to the antenna. In both versions, the surrounding metal layer is severed from the location of either security tag to the edge of the liner.

### CROSS-REFERENCE TO RELATED APPLICATIONS

This utility application claims the benefit under 35 U.S.C. §119(e) of Provisional Application Ser. No. 60/752,987 filed on Dec. 22, 2005 entitled SECURITY TAG FOR CIGARETTE PACK and whose entire disclosure is incorporated by reference herein.

### BACKGROUND OF THE INVENTION

1. Field of the Invention

The current invention relates to security tags and more particulary, discloses integrating a security tag in the liner (e.g., aluminum) of a cigarette pack

2. Description of Related Art

Tracking or detecting the presence or removal of retail items from an inventory or retail establishment comes under the venue of electronic article surveillance (EAS), which also now includes radio frequency identification (RFID). EAS or RFID detection is typically achieved by applying an EAS or RFID security tag to the item or its packaging and when these security tags are exposed to a predetermined electromagnetic field (e.g., pedestals located at a retail establishment exit), they activate to provide some type of alert and/or supply data to a receiver or other detector.

However, the application of the EAS or RFID security tag to the item or its packaging in the first instance can be expensive and wasteful of resources used to form the security tag. For example, EAS security tags, typically comprise a resonant circuit that utilize at least one coil and at least one capacitor that operate to resonate when exposed to a predetermined electromagnetic field (e.g., 8.2 MHz) to which the EAS tag is exposed. By way of example only, the coil and the capacitor are etched on a substrate whereby a multi-turn conductive trace (thereby forming the coil) terminates in a conductive trace pad which forms one plate of the capacitor. On the opposite side of the substrate another conductive trace pad is etched to form the second capacitor plate, while an electrical connection is made through the substrate from this second plate to the other end of the coil on the first side of the substrate; the non-conductive substrate then acts as a dielectric between the two conductive trace pads to form the capacitor. Thus, a resonant circuit is formed. Various different resonant tag products are commercially available and described in issued patents, for example, U.S. Pat. Nos. 5,172,461; 5,108,822; 4,835,524; 4,658,264; and 4,567,473 all describe and disclose electrical surveillance tag structures. However, such products utilize, and indeed require, substrates which use patterned sides of conductive material on both face surfaces of the substrate for proper operation. Special conductive structures and manufacturing techniques must be utilized on both substrate faces for producing such resonant tag products. Currently available EAS tag structures have numerous drawbacks. For example, since special patterning and etching techniques must be utilized on both sides of the available tags to produce the proper circuit, per unit processing time and costs are increased. Furthermore, the complexity of the manufacturing machinery required for production is also increased. Oftentimes, complex photo-etching processes are used to form the circuit structures. As may be appreciated, two sided photo-etching is generally time consuming and requires precise alignment of the patterns on both sides. Additional material is also necessary to pattern both sides, thus increasing the per unit material costs.

With particular regard to radio frequency identification (RFID) tags, RFID tags include an integrated circuit (IC) coupled to a resonant circuit as mentioned previously or coupled to an antenna (e.g., a dipole) which emits an information signal in response to a predetermined electromagnetic field (e.g., 13.56 MHz). Recently, the attachment of the IC has been accomplished by electrically-coupling conductive flanges to respective IC contacts to form a “chip strap.” This chip strap is then electrically coupled to the resonant circuit or antenna. See for example U.S. Pat. No. 6,940,408 (Ferguson, et al.); U.S. Pat. No. 6,665,193 (Chung, et al.); U.S. Pat. No. 6,181,287 (Beigel); and U.S. Pat. No. 6,100,804 (Brady, et al.).

Applying such EAS or RFID security tags to cigarette cartons, let alone to each cigarette pack can be expensive. Moreover, the presence of the foil layer in each cigarette pack can distort or otherwise affect EAS or RFID security tag performance. In addition, there needs to be means for de-activating the security tag if used on or with the cigarette pack once the pack is opened. Thus, there remains a need for more efficiently providing or integrating a security tag on or with items and/or their packaging where an aluminum layer is already associated with the item and/or its packaging as well as being able to de-activate the security tag once the cigarette pack is opened.

All references cited herein are incorporated herein by reference in their entireties.

### BRIEF SUMMARY OF THE INVENTION

A cigarette pack liner comprising: a non-conductive layer (e.g., paper); a metal layer (e.g., aluminum) secured to the non-conductive layer, wherein the metal layer has a portion removed therefrom that exposes a portion ofthe non-conductive layer, and wherein the exposed portion of the non-conductive layer comprises a capacitor plate and a first lead is electrically isolated from the remainder of the metal layer; and a coil comprising a second capacitor plate located at a first end ofthe coil, wherein the coil is secured to the exposed portion ofthe non-conductive layer and whereby the second capacitor plate is positioned over the first capacitor plate, and wherein the coil comprises a second end having a second lead, and wherein the first and second leads are electrically-coupled together to form a security tag in the liner.

A method of producing a cigarette pack liner comprising a security tag or inlay formed of a metal layer and wherein the cigarette pack liner also comprises a non-conductive layer. The method comprises the steps of: applying an adhesive around a margin ofthe non-conductive layer such that a region ofthe non-conductive layer is surrounded by adhesive and wherein a portion of the margin that extends from the region of the non-conductive layer to an edge of the liner also contains no adhesive, and wherein the region further comprises adhesive in the shape of a capacitor plate and lead; applying a metal layer to the non-conductive layer having said adhesive thereon; cutting the metal layer in the form of the region such that a first capacitor plate and first lead are disposed in the region; removing all portions of the metal layer that are not coupled to the non-conductive layer by the adhesive; applying an adhesive to an underside of a preformed coil having a second lead and a second capacitor plate at respective ends of the preformed coil; disposing the preformed coil in the region, wherein the preformed coil and second capacitor plate are positioned such that the second capacitor plate overlies the first capacitor plate to form a capacitor and wherein at least a portion of the second lead overlaps the first lead; and crimping the first and second leads to form the security tag in the liner.

A cigarette pack liner comprising: a non-conductive layer (e.g., paper); and a metal layer (e.g., aluminum) secured to the non-conductive layer, wherein the metal layer has a portion removed therefrom that exposes a portion of the non-conductive layer, and wherein the exposed portion of the non-conductive layer comprises an antenna; and a radio frequency identification (RFID) integrated circuit coupled to the antenna for forming a security tag in the liner.

A method of producing a cigarette pack liner comprising an integrated security tag or inlay formed of a metal layer and wherein the cigarette pack liner also comprises a non-conductive layer. The method comprises the steps of: applying a patterned adhesive to the non-conductive layer, wherein the patterned adhesive applied on the non-conductive layer has the form of at least one loop having two respective ends; applying a metal layer to the non-conductive layer having the patterned adhesive thereon; cutting the metal layer in the form of at least one loop having two respective ends to form a coil or antenna in the metal layer; removing all portions of the metal layer that are not coupled to the non-conductive layer by any portion of the patterned adhesive; and coupling a radio frequency identification (RFID) integrated circuit to the antenna.

### BRIEF DESCRIPTION OF SEVERAL VIEWS OF THE DRAWINGS

The invention will be described in conjunction with the following drawings in which like reference numerals designate like elements and wherein:

FIG. 1 is an isometric view of the cigarette pack liner showing the integrated security tag thereon, along with the tear-away portion that includes part of the security tag;

FIG. 2 is an exploded isometric view of the cigarette pack liner (also referred to as the “foil liner”), shown in partial view, along with the tools, the lower one of which is also shown in partial view, into which a security tag is to be formed;

FIG. 3 is an isometric view ofthe cigarette pack liner positioned on the lower die just after the upper die has cut the metal layer of the cigarette pack liner and has been moved upward;

FIG. 4 is an exploded view showing the portion of the metal layer that has been removed from the cigarette pack liner to form a capacitor plate and lead of the security tag;

FIG. 5 is an exploded view showing how an external coil and the other capacitor plate are coupled to the cigarette pack liner;

FIG. 6 is an exploded isometric view of the cigarette pack liner, shown in partial view, including the security tag just prior to an upper die crimping a portion of the coil to electrically couple the coil and the capacitor together while pressing the coil and upper capacitor plate to the cigarette pack liner;

FIG. 7 is an enlarged view of the crimped region after the upper die has been applied;

FIG. 8 is an enlarged partial cross-sectional view of the security tag of the cigarette pack liner taken along line 8-8 of FIG. 6 before the crimping and pressure occurs;

FIG. 9 is a partial cross-sectional view of the security tag ofthe cigarette pack liner taken along 9-9 of FIG. 7 after the crimping and pressure has occurred;

FIG. 10 is an isometric view showing a plurality of cigarette packs having the integrated security tags as part of their pack liners inside a carton (shown in phantom) and wherein the cigarette packs are arranged in the carton such that the security tags are facing outwards to facilitate deactivation at the point of sale;

FIG. 11 is an isometric view of the cigarette pack liner showing a second embodiment of an integrated security tag thereon, along with the tear-away portion that includes part of the security tag;

FIG. 12 is an exploded isometric view of the cigarette pack liner (also referred to as the “foil liner”), shown in partial view, along with the tools, the lower one of which is also shown in partial view, into which the second embodiment of the security tag is to be formed;

FIG. 12A is an isometric view of the cigarette pack liner positioned on the lower die just after the upper die has cut the metal layer of the cigarette pack liner for the second embodiment and has been moved upward;

FIG. 13 is an exploded view showing the portion of the metal layer that has been removed from the cigarette pack liner to form the antenna portion of the security tag of the second embodiment;

FIG. 14 is a cross-sectional view of the chip strap coupled to the dipole antenna of the second embodiment taken along line 14-14 of FIG. 11;

FIG. 15 is across-sectional view, taken along line 15-15 of FIG. 13, ofthe upper and lower dies sandwiching the cigarette pack liner to cut the metal layer to form the integrated security tag of the second embodiment; and

FIG. 16 is a cross-sectional view taken along line 15-15 of FIG. 13, of the cigarette pack liner containing the integrated security tag of the second embodiment positioned on top of the lower tool.

### DETAILED DESCRIPTION OF THE INVENTION

The apparatus and method ofthe present invention takes advantage of the presence ofthe metal-layered liner, e.g., an aluminum layer having a paper backing, that is present in all cigarette packs. Instead of applying a security tag to the cigarette pack, the apparatus and method of the present invention integrates a security tag into the metal layer of the liner during the liner formation. Thus, once the liner is completed, a security tag (e.g., an EAS security tag or an RFID security tag) is embedded in the liner itself. Moreover, these security tags can be deactivated at the point of sale (POS) by the cashier; in addition, once the cigarette pack is opened by a user, manipulation of the liner (e.g., removing a tear-away portion) to obtain access to the cigarettes, also de-activates the security tag.

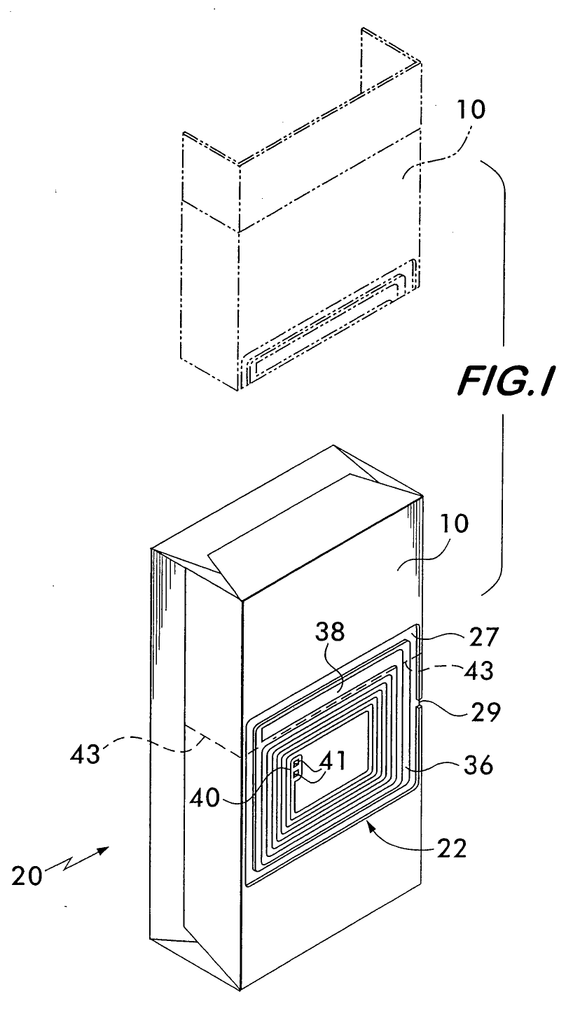

FIG. 1 depicts the cigarette pack liner 20 having an integrated security tag 22; a second embodiment (which will be discussed in detail later) security tag 122 is shown in FIG. 11 but it should be understood that these are by way of example only and that other security tag variations integrated with the liner could have been shown. The key feature of the present invention is that the security tag is formed as part of the cigarette pack liner assembly.

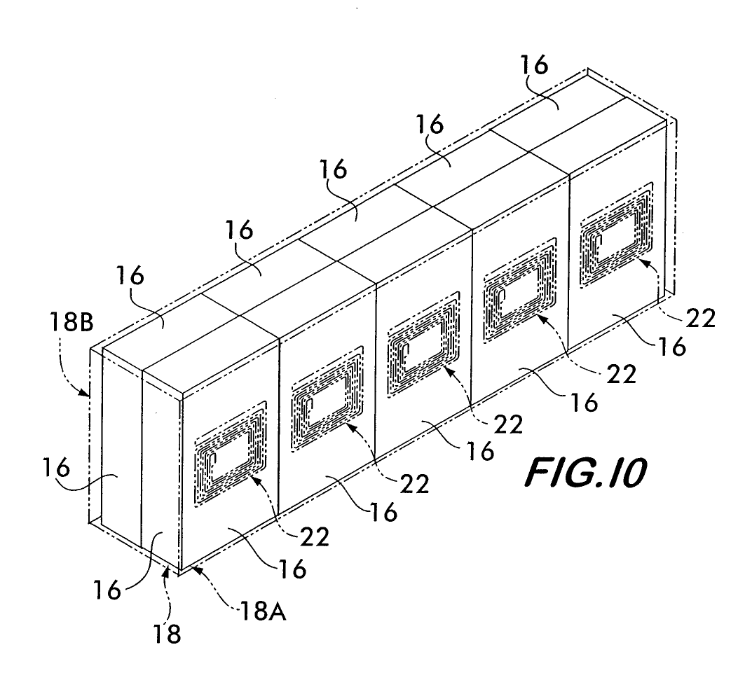

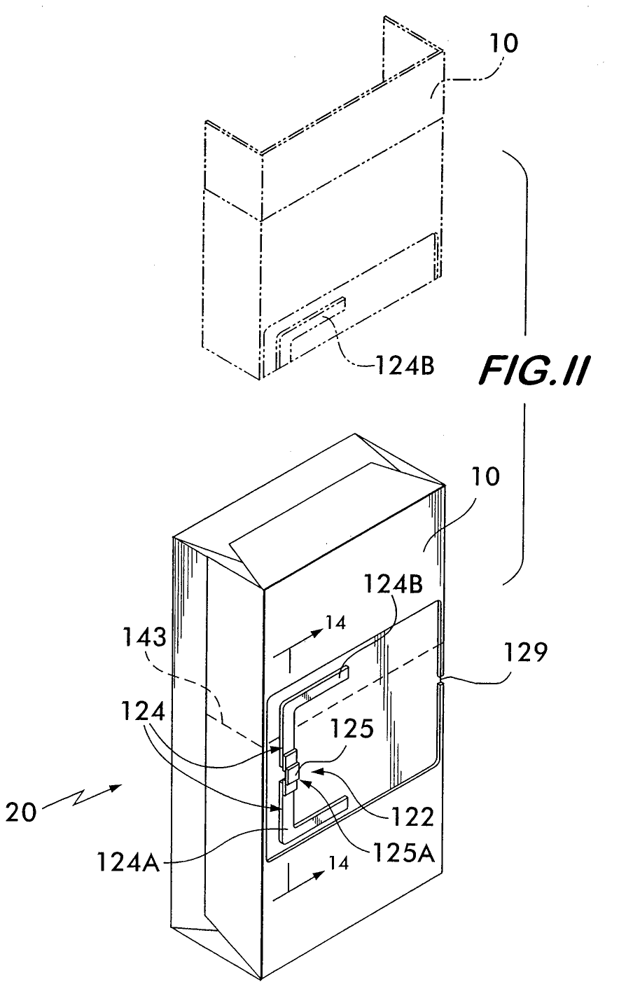

As can be seen most clearly from FIG. 1, the liner 20 is formed into a rectangular prism that conforms to the interior of the cigarette pack 16 (see FIG. 10). Conventional cigarette pack liners comprise a removable upper portion that is removed from the pack to expose the cigarettes. The liner 20 of the present invention utilizes this feature of a removable upper portion 10 as a means of de-activating the integrated security tag 22 (or security tag 122, FIG. 11) once the cigarette pack 16 is opened. Because the liner 20 has a shape memory, the cigarette pack 16 is formed around the liner 20. In particular, once the security tag 22 (or security tag 122) is completed, the liner 20 is releasably wrapped around a mandrel (not shown). Adhesive is applied at different locations around the liner 20. The mandrel can be rotated so that the cigarette pack can be folded/wrapped around the liner 20, thereby adhesively securing the liner 20 inside the cigarette pack 16. The cigarette pack/liner assembly is then removed from the mandrel and filled with cigarettes. Once filled, the removable upper portion of the liner is folded properly with the tear-away portion 10 positioned to be visible and accessible to the patron once the lid of the cigarette pack is opened. Once opened, the patron grasps the tear away portion and pulls it away from the liner, thereby exposing the cigarettes and simultaneously destroying the security tag 22 (or security tag 122).

Conventional cigarette pack liners comprise a metal layer (e.g., aluminum) secured to a backing layer such as paper. This metal layer gives the liner a shape memory mentioned previously. However, to form the integrated security tags ofthe present invention into the liner, it is necessary to modify the manufacture of the liner itself.

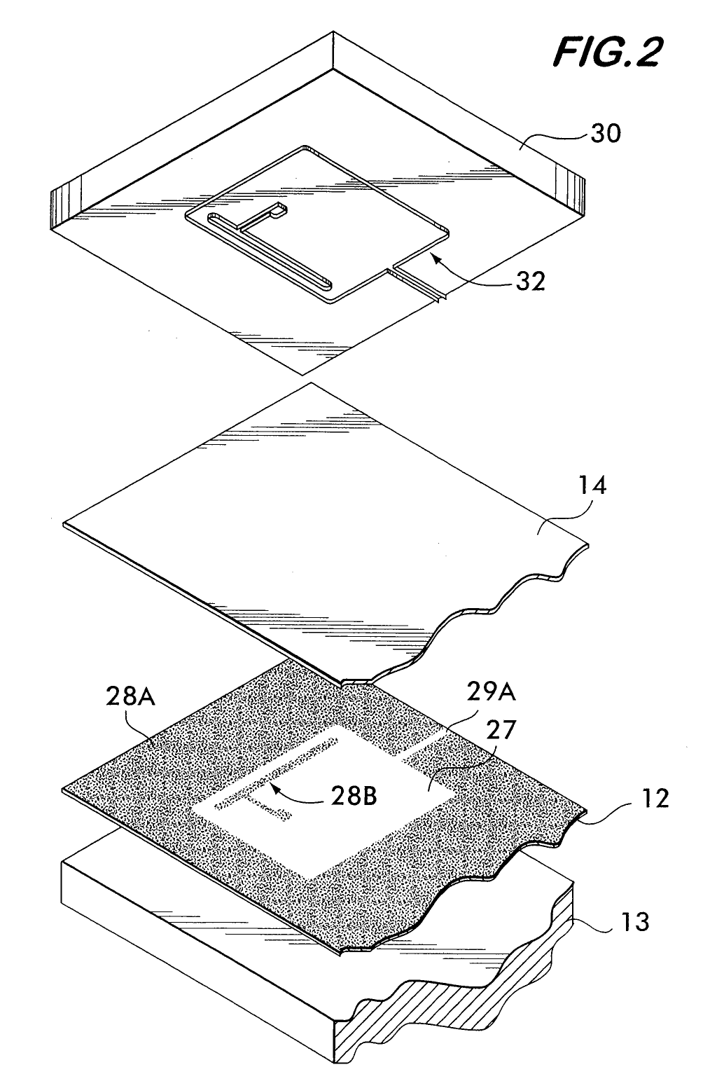

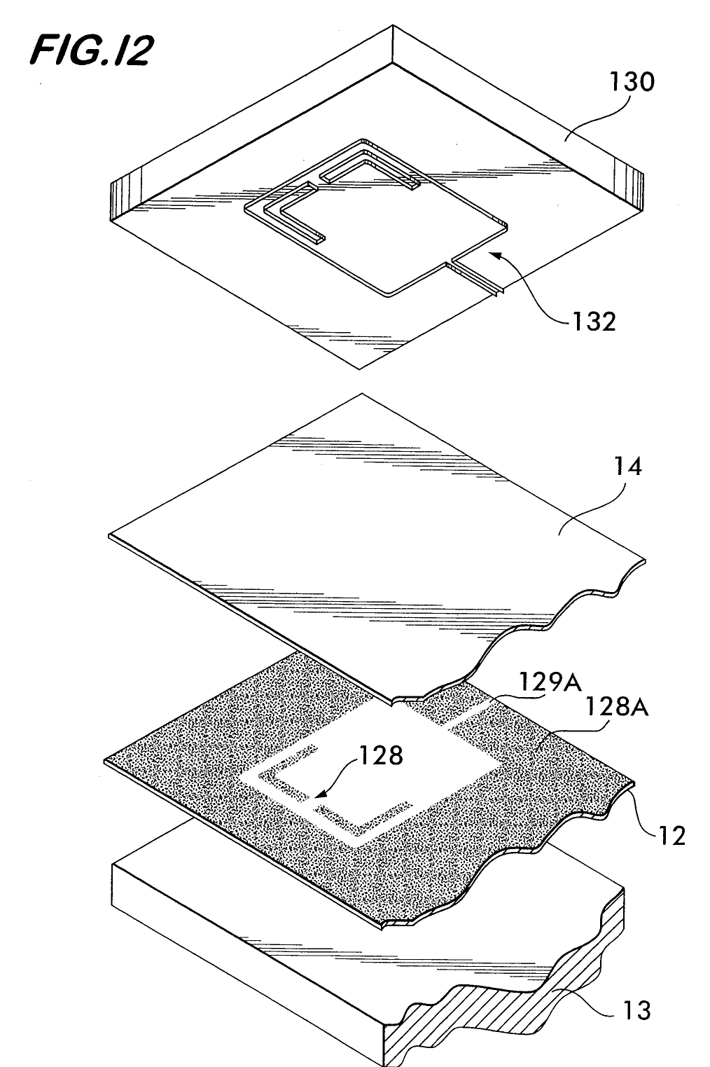

FIGS. 2-10 are directed to an integrated security tag 22 that operates in the EAS security tag range (e.g., 2 MHz-14 MHz). FIGS. 11-16 are to an integrated security tag 122 that operates in the RFID range (e.g., UHF range, approximately: 850 MHz-950 MHz or microwave range: 2.3 GHz-2.6 GHz).

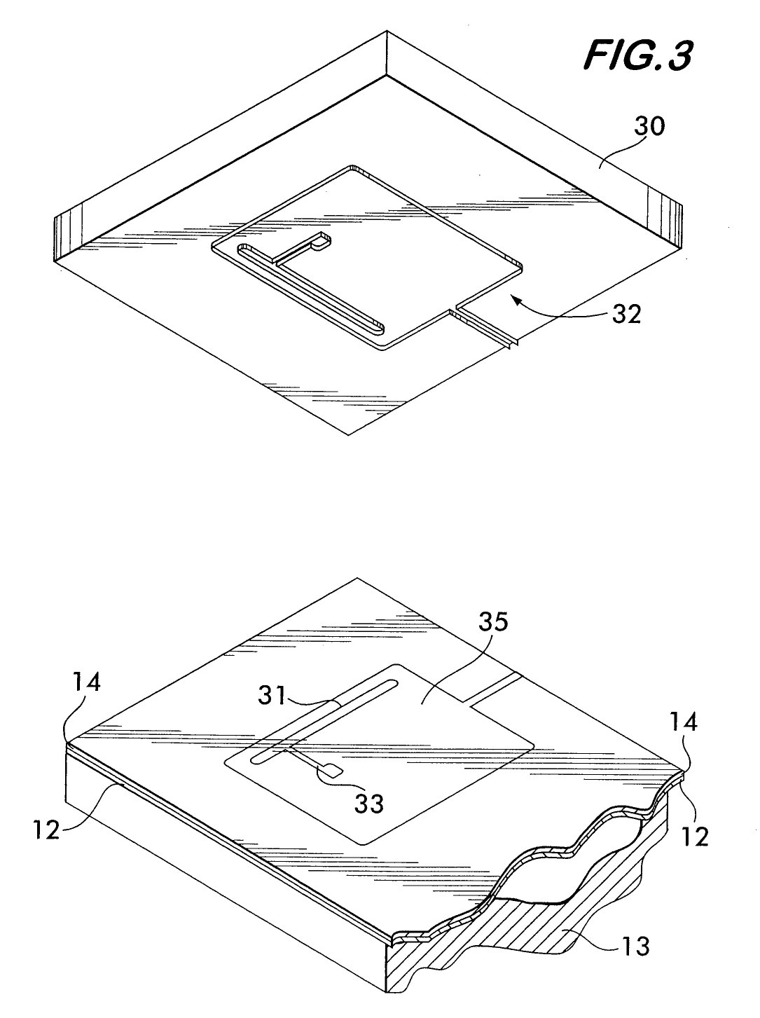

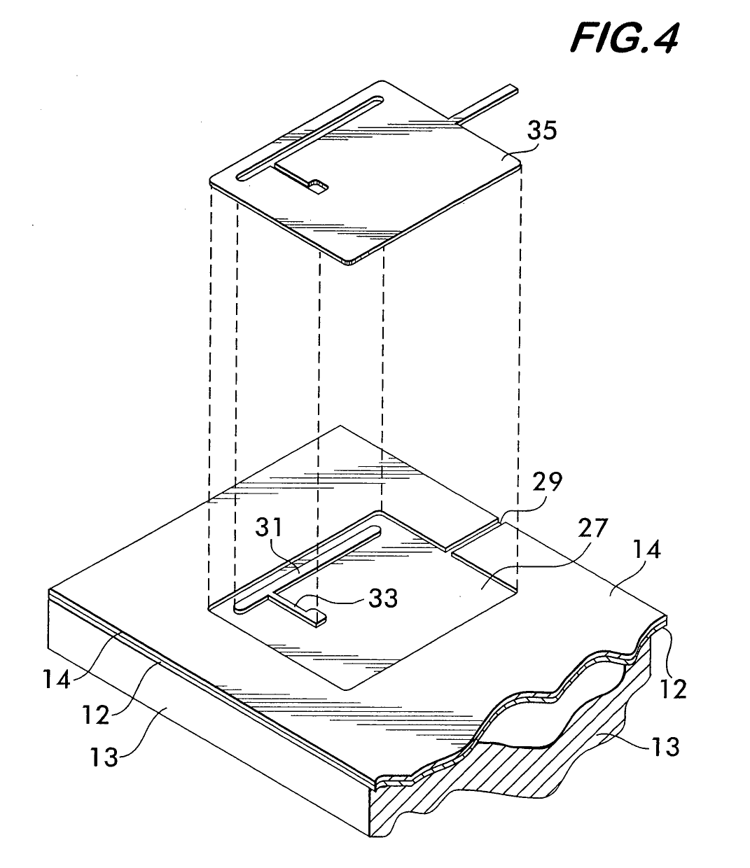

To that end, FIG. 2 shows a partial exploded view of the layers forming the liner and the tools used to create the security tag 22. In particular, the backing layer is a non-conductive layer 12 (e.g., paper) that is positioned on top of a lower die 13. An adhesive is then applied to the non-conductive layer 12 as follows: An adhesive 28A is applied along the margin of the non-conductive layer 12, thereby forming a central portion 27 having no adhesive. It should also be noted that the margin adhesive 28A is not continuous in that a small path 29A having no adhesive is formed between the central portion 27 and the edge of the non-conductive layer 12. Finally, an isolated patch 28B of adhesive is provided within the central portion 27. The shape of this adhesive patch 28B may vary. By way of example only, the patch 28B is in the form of a capacitor plate and lead. Next, a metal layer 14 (e.g., aluminum) is applied on top of the non-conductive layer 12 having the adhesive. As can be appreciated, the application of the metal layer 14 to the non-conductive layer 12 secures the metal layer 14 everywhere to the non-conductive layer 12 except at those locations where there is no adhesive. An upper die 30 having a cutter 32 formed in the same shape as the central portion 27 and the isolated patch 28B is then applied to the metal layer 14/non-conductive layer 12 laminate. This results in the severing ofthe metal layer 14 in a form 35 representative of the central portion 27, a capacitor plate 31 and lead 33, and the small path 29A, as shown in FIG. 3. As a result, the portion 35 is not secured to the non-conductive layer 12. FIG. 4 shows the form 35 being removed from the metal layer 14, thereby resulting in the central portion 27, channel 29, capacitor plate 31 and lead 33. The removed metal portion 35 can be re-used, thereby minimizing any wasting ofthe metal layer 14.

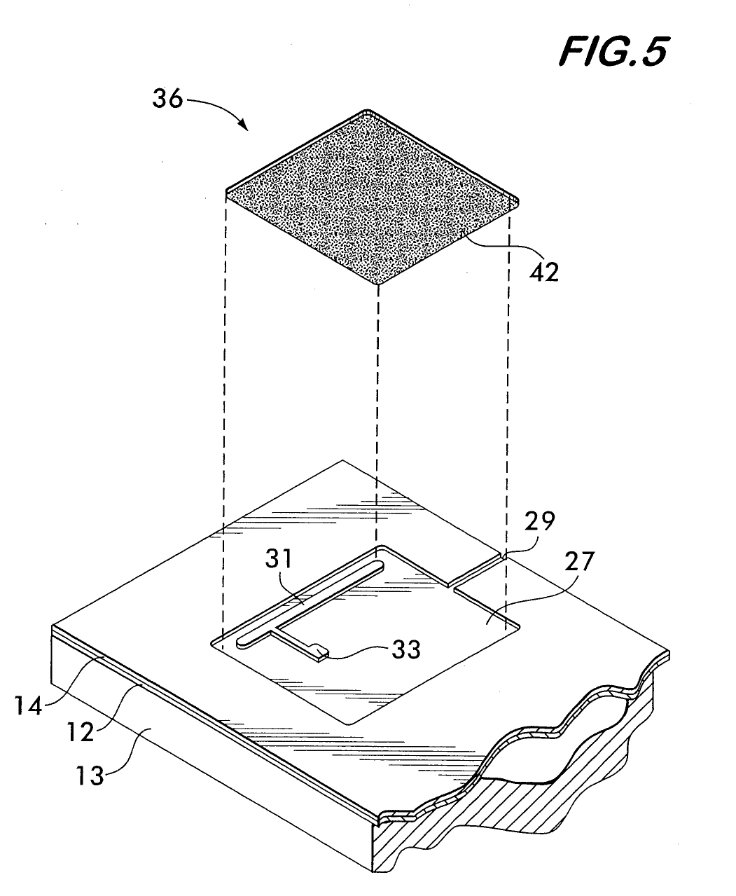

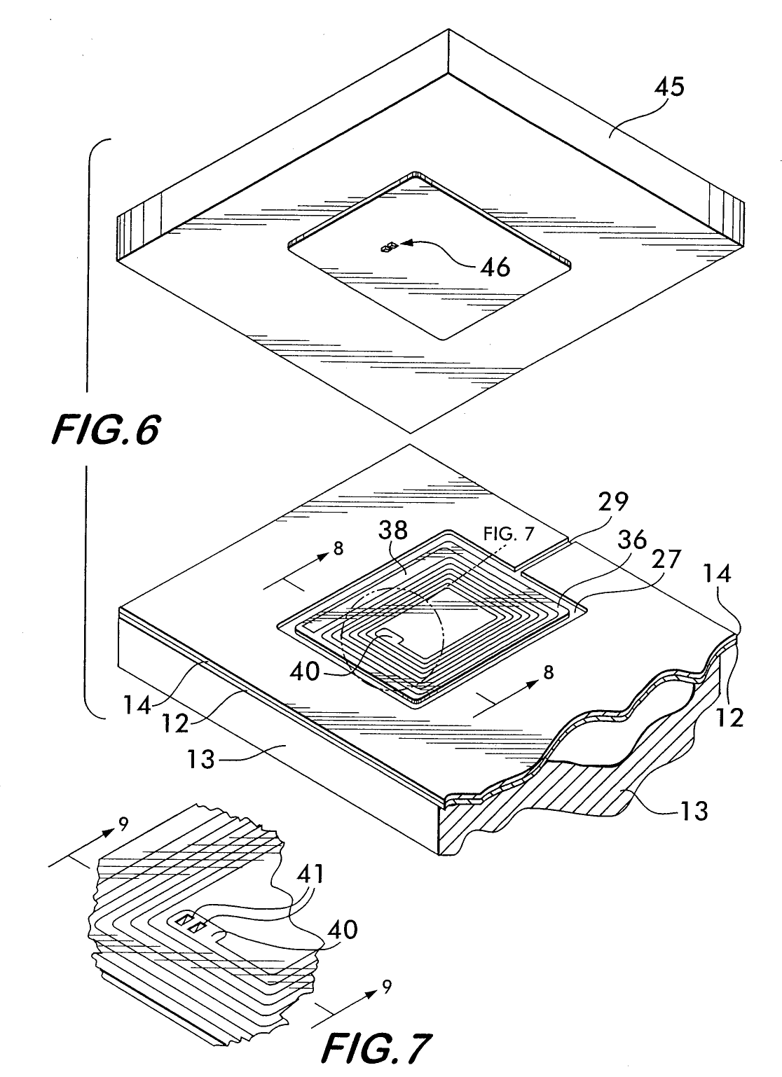

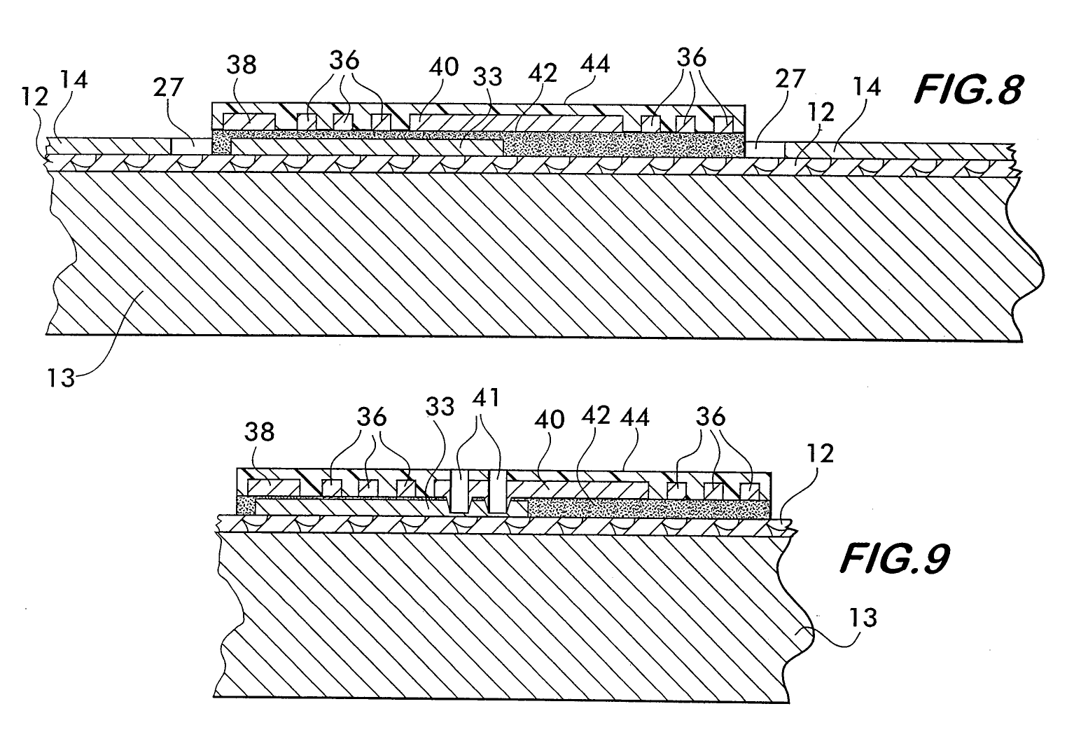

FIG. 5 depicts the underside of a preformed, multi-turn coil 36 (FIG. 6) having a capacitor plate 38 (FIG. 6) and associated lead 40 (FIG. 6) that is coated with an adhesive 42 (e.g., a heat seal dielectric material such as polyester or polyethylene which readily bonds to aluminum; however, other dielectric materials, such as a styrene-acylate polymer or a vinyl acetate could also be used). This preformed coil supported by a resin 44 (FIG. 8) so that it can be handled and secured to the liner 20 as described next. The preformed coil 36 is oriented such that the capacitor plate 38 is aligned to be positioned over the capacitor plate 31; similarly, the lead 40 is positioned to overlap a portion ofthe lead 33. Pressure and heat are applied by another upper die 45 that secures the coil 36 to the non-conductive layer 12, while forming a capacitor using capacitor plates 31 and 38 and while electrically coupling the leads 33 and 40 together. In particular, when the die 45 presses the body of the coil 36 against the paper, the adhesive 42 comes into contact with the non-conductive layer 12 thereby securing the coil 36 thereto. At the same time, the adhesive 42 under the capacitor plate 38 acts as the dielectric between capacitor plate 31 and 38, thereby forming the capacitor for the security tag 22. Furthermore, the die 45 also includes crimping projections 46 that crimp the two leads 33 and 40 together; the adhesive 42 located under lead 40 further facilitates making a secure electrical connection between these two leads 33 and 40. The crimping of leads 33 and 40 together electrically coupled the capacitor plate 31 to the preformed coil 36. Thus, the security tag 22 is formed comprising the coil 36 and capacitor formed ofthe plates 31 and 38 and the dielectric adhesive 42 positioned therebetween.

FIG. 8 depicts the preformed coil 36 and associated parts positioned on the central portion before the upper die 45 is applied. As can be seen, the coil 36 and its associated parts fit within the central region 27 without making any contact with the surrounding metal layer 14, thereby isolating the coil 36 from the metal layer 14. Portions of the leads 33 and 40 overlap with the adhesive 42 in between. Thus, when the upper die 45 is applied against the resin 44, the adhesive 42 is compressed everywhere, as shown in FIG. 9, and the crimping projections 46 act to intermesh the leads 33 and 40, as well as the adhesive 42, to form a secure electrical connection. See FIG. 7 which shows an enlargement of the crimped leads 31 and 40 and showing cavities 41 formed in the crimped portions.

The security tag 22 thus formed is located within the central region 27 of the liner 20 and isolated from the remaining metal layer 14 by a gap (e.g., approximately 0.10 inches). In addition, the channel 29 forms a break in the margin of the metal layer 14. Testing has demonstrated that by breaking this closed-loop margin using the channel 29 (e.g., approximately 0.10 inches), a stronger response signal from the security tag 22 is obtained.

Once the security tag 22 is formed and the liner 20 and cigarette pack 16 assembled, to facilitate the deactivation of a plurality of these security tags 22, each cigarette pack 16 is placed into the cigarette carton 18 (shown in phantom) such that the side of the cigarette pack 16 that is adjacent the security tag 22 is facing outward. Thus, at checkout at the point of sale, the cashier swipes both sides 18A and 18B of the carton 18 across the deactivator (not shown). The deactivator may comprise a device that applies a high intensity electric field that causes sufficient energy to short the capacitor plates and thereby deactivate each tag 22 in the carton 18. By way of example only, this can be accomplished by including a dimple in the tag capacitor plates or other methods such as those disclosed in U.S. Pat. No. 5,861,809 (Eckstein, et al.) which is incorporated by reference herein.

An alternative way of deactivating the security tag 22 such that once the cigarette pack is validly purchased and opened, it will not respond to an EAS interrogator field, the liner 20 is perforated as described below. As shown in FIG. 1, the upper portion 10 of the liner of the cigarette pack is typically severed from the remaining portion of the liner. Thus, when the pack is opened, the user pulls the upper portion out of the pack and discards it, thereby exposing the cigarettes. In the present invention, before the coil 36 is applied to the central portion 27 and before the liner 20 is applied to the mandrel (not shown), the liner 20 is perforated to form an upper portion 10 of the liner 20. The perforation 43 is made through both the metal layer 14 and the non-conductive layer 12 of the liner except in the central portion 27 where the metal layer 14 has been removed, specifically portion 35; it should be noted that the perforation 43 is not made through the lead 33 located in the central portion 27. When the user pulls on the upper portion 10 to remove it, shot tabs (not shown) which hold the upper portion 10 to the liner 20, are severed and the capacitor (plates 31/38) is torn from the coil 36, thereby de-activating the security tag 122.

The second embodiment of the security tag 122 (FIGS. 11-16) is now discussed. As mentioned previously, the second embodiment of the security tag 122 operates in the RFID range (e.g., UHF range, approximately: 850 MHz-950 MHz or microwave range: 2.3 GHz-2.6 GHz).

The integrated security tag 122 comprises an antenna 124 (e.g., a dipole) that is formed in the metal layer of the liner 20 and wherein an RFID IC 125 (e.g., a chip strap 125A) is coupled thereto to form an integrated RFID security tag 122. Thus, if the cigarette pack container with the liner 20 is subjected to an RFID reader field, and the security tag 122 of the liner 20 is tuned to the frequency (e.g., UHF range, approximately: 850 MHz-950 MHz or microwave range: 2.3 GHz-2.6 GHz) of the RFID reader field, the security tag 122 will respond.

FIGS. 11-16 depicts the method of creating the integrated security tag 122 in the liner 20. As mentioned previously, conventional cigarette pack liners comprise a metal layer (e.g., aluminum) secured to a backing layer such as paper. This metal layer gives the liner a shape memory mentioned previously. However, to form the integrated security tag 122 of the present invention into the liner 20, it is necessary to modify the manufacture of the liner itself.

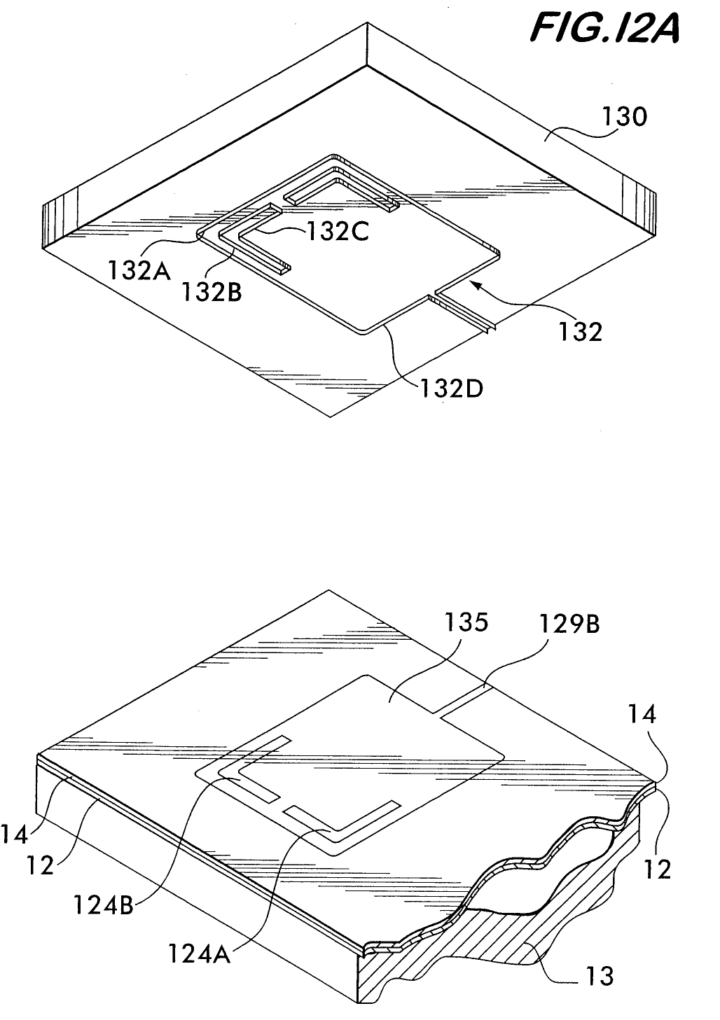

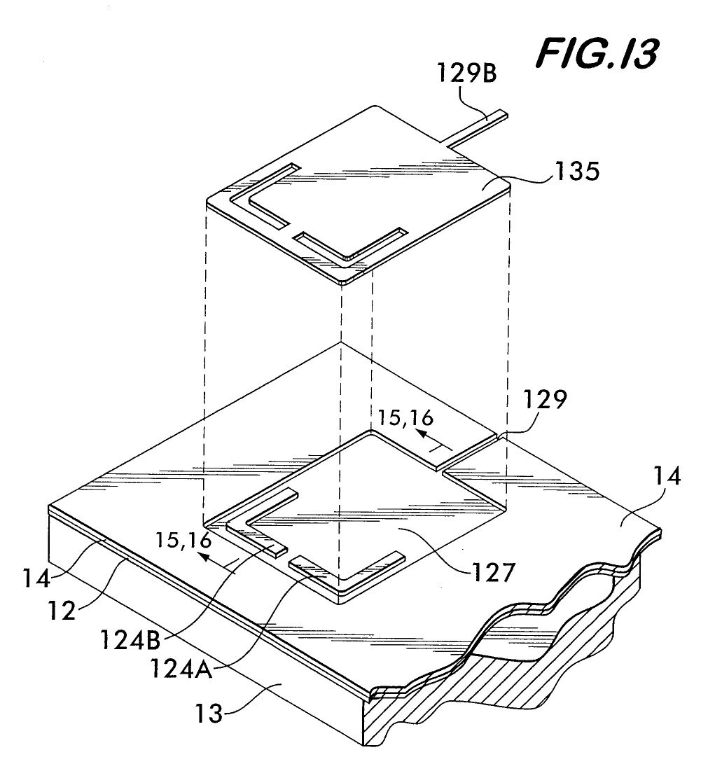

To that end, FIG. 11 shows a partial exploded view ofthe layers forming the liner and the tools used to create the security tag 122. In particular, the backing layer is a non-conductive layer 12 (e.g., paper) that is positioned on top of a lower die 13. A patterned adhesive is then applied to the non-conductive layer 12. The patterned adhesive 128 takes the form of the security tag antenna that is to be formed. By way of example only, FIG. 11 shows a patterned adhesive 128 in the form of a dipole antenna. Also adhesive 128A is applied along the margin ofthe non-conductive layer 12, thereby forming a central portion 127 having no adhesive. It should also be noted that the margin adhesive 128A is not continuous in that a small path 129A, having no adhesive, which is formed between the central portion 127 and the edge of the non-conductive layer 12. Next, a metal layer 14 (e.g., aluminum) is applied on top of the non-conductive layer 12 having the adhesive. As can be appreciated, the application of the metal layer 14 to the non-conductive layer 12 secures the metal layer 14 everywhere to the non-conductive layer 12 except at those locations where there is no adhesive. An upper die 130 having a cutter 132 formed in the same shape as the patterned adhesive 128 and the central portion 127 is then applied to the metal layer 14/non-conductive layer 12 laminate. This results in the severing of the metal layer 14 in the form ofthe central portion 127 and stem 129B, shown by the reference number 135; thus, as a result, the portion 135 is not secured to the non-conductive layer 12. FIG. 13 shows the form 135 being removed from the metal layer 14, thereby resulting in the dipole antenna 124 being located within the central region 127 and a channel 129 being formed from the central portion 127 to the edge of the non-conductive layer 12. The removed metal portion 135 can be re-used, thereby minimizing any wasting of the metal layer 14.

FIG. 15 shows the cutting edges 132A, 132B, 132C and 132D of the cutter 132 severing the metal layer 14 to form the antenna 124; in particular, these edges 132A-132D sever the non-adhesively secured portions (which corresponds to portion 135 as described previously) of the metal layer 14 but not the adhesively-secured portions of the metal layer 14 which forms the antenna 124. FIG. 16 is similar to the view of FIG. 15 but with the upper die 130 lifted away and with the severed portion 135 removed. Thus, the result of this process is a dipole antenna 124 (having elements 124A and 124B) which is isolated from the remaining portion ofthe metal layer 14, and wherein the metal layer 14 forms a nearly complete metal path around the central portion 127 except that it is interrupted by the channel 129, as can be seen most clearly in FIG. 13. It should noted that the presence of the channel 129 (e.g., approximately 0.10 inches), as discussed previously with respect to the first security tag embodiment 22, results in a stronger response signal from the security tag 122. It should also be noted that the although the dipole elements 124A/124B are shown closer to one edge of the central portion 127, that is by way of example only; the important feature is that the elements 124A/124B are electrically isolated from the remaining metal layer 14.

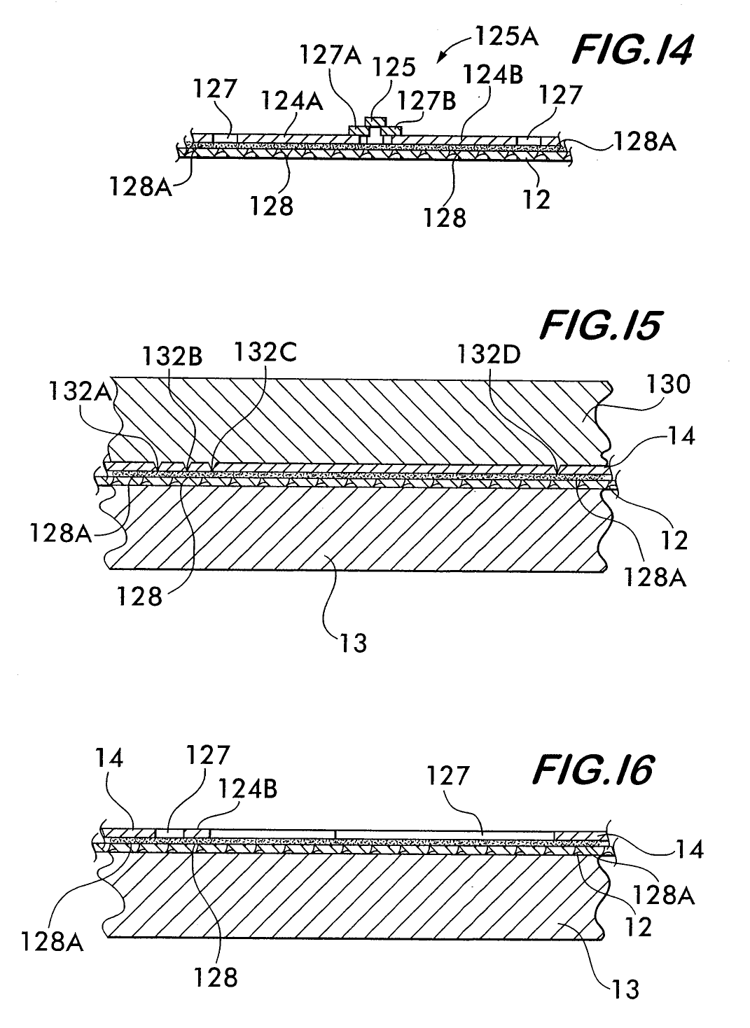

Once the antenna 124 is formed, the security tag 122 is completed by the application of a chip strap 125A (to form an RFID security tag) across the facing ends of dipole elements 124A and 124B of the antenna 124, as shown in FIGS. 11 and 14. As mentioned previously, the chip strap 125A comprises an RFID IC 125 and terminals 127A and 127B (FIG. 14) that are electrically coupled (e.g., crimp/adhesive mentioned previously with respect to the first embodiment) to respective dipole elements 124A and 124B to form the RFID security tag 122. Chip straps are known in the art, such as those shown in U.S. Pat. No. 6,940,408 (Ferguson, et al.); U.S. Pat. No. 6,665,193 (Chung, et al.); U.S. Pat. No. 6,181,287 (Beigel); and U.S. Pat. No. 6,100,804 (Brady, et al.), as well as in A.Ser. No. 60/730,053 and all of whose disclosures are incorporated by reference herein.

Once the security tag 122 is formed and the liner 20 and cigarette pack 16 assembled, to facilitate the deactivation of a plurality of these security tags 22, each cigarette pack 16 is placed into the cigarette carton 18 (shown in phantom) such that the side of the cigarette pack 16 that is adjacent the security tag 122 is facing outward, as described earlier with respect to the first security tag 22 embodiment. Thus, at checkout at the point of sale, the cashier swipes both sides 18A and 18B of the carton 18 across the deactivator (not shown). The deactivator may comprise a device that applies a high intensity electric field that causes sufficient energy to short the dipole elements 124A and 124B and thereby deactivate each tag 122 in the carton 18. By way of example only, this can be accomplished by deactivation methods such as those disclosed in U.S. Pat. No. 5,861,809 (Eckstein, et al.) which is incorporated by reference herein.

An alternative way of deactivating the security tag 122 such that once the cigarette pack is validly purchased and opened, it will not respond to an RFID reader field, the liner 20 is perforated as described below. As shown in FIG. 11, the upper portion 10 of the liner of the cigarette pack is typically severed from the remaining portion of the liner. Thus, when the pack is opened, the user pulls the upper portion out of the pack and discards it, thereby exposing the cigarettes. In the present invention, after the portion 135 is removed and before the liner 20 is applied to the mandrel (not shown), the liner 20 is perforated to form the portion 10 of the liner 20. The perforation 143 is made through both the metal layer 14 and the non-conductive layer 12 of the liner except in the central portion 127 where the metal layer 14 has been removed, specifically portion 135; it should be noted that the perforation 143 is not made through the dipole element 124B located in the central portion 127. When the user pulls on the upper portion 10 to remove it, shot tabs (not shown) which hold the upper portion 10 to the liner 20, are severed and the dipole element 124B is torn, thereby deactivating the security tag 122.

As mentioned earlier, patterned adhesive is applied to the non-conductive layer 12. The details of this patterned adhesive application and cutting procedure are provided in U.S. application Ser. No. 10/235,733 entitled “Security Tag and Process for Making Same” filed Sep. 5, 2002 and U.S. application Ser. No. 10/998,496 entitled “A Method for Aligning Capacitor Plates in a Security Tag and a Capacitor Formed Thereby” filed on Nov. 29, 2004, and all of whose entire disclosures are incorporated by reference herein.

It should further be understood that the coil 36/antenna 124 shown is by way of example only. Upper dies 30/130 having different cutters 32/132 can create single loop coils or antennas.

The term “inlay” as used throughout this Specification means that the completed tag (e.g., an EAS tag or RFID tag) may themselves either form a portion of a label or be coupled to a label for use on, or otherwise associated with, an item.

While the invention has been described in detail and with reference to specific examples thereof, it will be apparent to one skilled in the art that various changes and modification can be made therein without departing from the spirit and scope thereof.

What is claimed is:

1. A cigarette pack liner comprising:
a non-conductive layer;
a metal layer secured to said non-conductive layer, said metal layer having a portion removed therefrom that exposes a portion of said non-conductive layer, said exposed portion of said non-conductive layer comprising a capacitor plate and a first lead electrically isolated from the remainder of said metal layer; and
a coil comprising a second capacitor plate located at a first end of said coil, said coil being secured to said exposed portion of said non-conductive layer and whereby said second capacitor plate is positioned over said first capacitor plate, said coil comprising a second end having a second lead, said first and second leads being electrically-coupled together to form a security tag in said liner.

2. The cigarette pack liner of claim 1 wherein an adhesive is applied to one side of said coil, said adhesive forming a dielectric between said first and second capacitor plates.

3. The cigarette pack liner of claim 2 wherein said adhesive is located between said first and second leads which are crimped together.

4. The cigarette pack liner of claim 1 wherein said removed portion of said metal layer comprises a central region of said metal layer that has been removed and further includes a portion of said metal layer that extends from an edge of said liner to said central region.

5. The cigarette pack liner of claim 1 wherein said metal layer comprises aluminum.

6. The cigarette pack liner of claim 1 wherein said non-conductive layer comprises paper.

7. The cigarette pack liner of claim 1 wherein said coil comprises a multi-turn coil.

8. The cigarette pack liner of claim 1 wherein said security tag responds to a signal in the frequency of approximately 2 MHz-14 MHz.

9. The cigarette pack liner of claim 1 including a perforation that permits a portion of said liner to be severed from said liner, said portion comprising at least a portion of said security tag.

10. The cigarette pack liner of claim 1 including a dimple in at least one of said first or second capacitor plates for facilitating deactivation of said security tag when a sufficiently high electric field is applied.

11. A method of producing a cigarette pack liner comprising a security tag or inlay formed of a metal layer and wherein the cigarette pack liner also comprises a non-conductive layer, said method comprising the steps of:
applying an adhesive around a margin of said non-conductive layer such that a region of said non-conductive layer is surrounded by adhesive and wherein a portion of said margin that extends from said region of said non-conductive layer to an edge of said liner also contains no adhesive, said region further comprising adhesive in the shape of a capacitor plate and lead;
applying a metal layer to said non-conductive layer having said adhesive thereon;
cutting said metal layer in said form of said region such that a first capacitor plate and first lead are disposed in said region;
removing all portions of said metal layer that are not coupled to said non-conductive layer by said adhesive;
applying an adhesive to an underside of a preformed coil having a second lead and a second capacitor plate at respective ends of said preformed coil;
disposing said preformed coil in said region, said preformed coil and second capacitor plate being positioned such that said second capacitor plate overlies said first capacitor plate to form a capacitor and wherein at least a portion of said second lead overlaps said first lead; and
crimping said first and second leads to form said security tag in said liner.

12. The method of claim 11 wherein said metal layer comprises aluminum.

13. The method of claim 11 wherein said non-conductive layer comprises paper.

14. The method of claim 11 wherein said coil comprises a multi-turn coil.

15. The method of claim 11 wherein said security tag responds to a signal in the frequency of approximately 2 MHz-14 MHz.

16. The method of claim 11 further comprising perforating a portion of said liner containing a portion of said security tag to permit said liner to be separated for deactivating said security tag.

17. The method of claim 11 further comprising including a dimple in said first or second capacitor plate to facilitate deactivation of said security tag when a sufficiently high electric field is applied.

18. A cigarette pack liner comprising:
a non-conductive layer;
a metal layer secured to said non-conductive layer, said metal layer having a portion removed therefrom that exposes a portion of said non-conductive layer, said exposed portion of said non-conductive layer comprising an antenna; and
a radio frequency identification (RFID) integrated circuit coupled to said antenna for forming a security tag.

19. The cigarette pack liner of claim 18 wherein said removed portion of said metal layer comprises a central region of said metal layer that has been removed and further includes a portion of said metal layer that extends from an edge of said liner to said central region.

20. The cigarette pack liner of claim 18 wherein said antenna comprises a gap between dipole elements of said antenna and across which said RFID integrated circuit is electrically coupled.

21. The cigarette pack liner of claim 18 wherein said metal layer comprises aluminum.

22. The cigarette pack liner of claim 18 wherein said non-conductive layer comprises polystyrene.

23. The cigarette pack liner of claim 18 further comprising a tear-away portion comprising a portion of said antenna.

24. The cigarette pack liner of claim 18 wherein said RFID integrated circuit comprises a chip strap.

25. The cigarette pack liner of claim 18 wherein said security tag responds to a signal of a frequency of approximately 850 MHz or greater.

26. The cigarette pack liner of claim 18 including a perforation that permits a portion of said liner to be severed from said liner, said portion comprising at least a portion of said security tag.

27. A method of producing a cigarette pack liner comprising an integrated security tag or inlay formed of a metal layer and wherein the cigarette pack liner also comprises a non-conductive layer, said method comprising the steps of:
applying a patterned adhesive to said non-conductive layer, said patterned adhesive applied on said non-conductive layer having the form of at least one loop having two respective ends;
applying a metal layer to said non-conductive layer having said patterned adhesive thereon;
cutting said metal layer in said form of at least one loop having two respective ends to form an antenna in said metal layer;
removing all portions of said metal layer that are not coupled to said non-conductive layer by any portion of said patterned adhesive; and
coupling a radio frequency identification (RFID) integrated circuit to said antenna.

28. The method of claim 27 wherein said step of coupling an RFID integrated circuit to said antenna comprises coupling said RFID integrated circuit between dipole elements of said antenna.

29. The method of claim 28 wherein said RFID integrated circuit comprises a chip strap.

30. The method of claim 27 further comprising the steps of perforating a portion of said cigarette pack liner that can be torn away, said step of perforating a portion of said cigarette pack liner further comprises perforating the non-conductive layer directly adjacent said antenna.

31. The method of claim 27 wherein said security tag responds to a signal of a frequency of approximately 850 MHz or greater.

32. The method of claim 27 further comprising perforating a portion of said liner containing a portion of said security tag to permit said liner to be separated for deactivating said security tag.
